(19) United States
(12) Patent Application Publication
(10) Pub. No.: US 2008/0130066 A1
(43) Pub. Date: Jun. 5, 2008

(54) CARRIAGE MOVING DEVICE

(75) Inventor: Yoshitaka Okamura, Yamato-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/945,786

(22) Filed: Nov. 27, 2007

(30) Foreign Application Priority Data
Nov. 30, 2006 (JP) 2006-323663

(51) Int. Cl. H04N 1/04

(52) U.S. Cl. 358/474

(57) ABSTRACT

A carriage moving device includes a main guide member configured to guide movement of a carriage, a sub-guide member configured to guide the movement of the carriage and to regulate rotation of the carriage, and an engaging portion provided in the carriage and configured to slide relative to the main guide member. The main guide member includes a first flat face extending vertically, and a second flat face extending in a direction such that a vertical upper portion is farther from the first flat face than a vertical lower portion. The engaging portion is in contact with the first and second flat faces.

### BACKGROUND OF THE INVENTION

1. Field of the Invention

The present invention relates to a carriage moving device that moves a recording head for recording an image on a recording sheet or a reading sensor for reading a document in a state in which the recording head or the reading sensor is mounted thereon. The present invention also relates to a recording apparatus and an image reading apparatus provided with the carriage moving device.

2. Description of the Related Art

For example, a printer, a copying machine, and a facsimile apparatus are used as recording apparatuses that perform recording on a recording sheet according to image information with a recording head mounted on a reciprocating carriage. Moreover, an image reading apparatus that reads an image on a document with a reading sensor mounted on a reciprocating carriage is used. In these apparatuses in which the carriage is moved, when the recording sheet or the document is scanned, the amplitude of rotational vibration particularly in the yawing direction (direction of rotation about the vertical axis) of the carriage has a great influence on image quality. For this reason, various proposals have been made to suppress vibrational yawing about the vertical axis.

U.S. Pat. No. 5,366,305 discloses an inkjet printer in which a carriage is supported by a shaft. FIG. 6 shows the structure of a bearing portion of the carriage disclosed in U.S. Pat. No. 5,366,305. Referring to FIG. 6, a guide shaft 200 is provided in a main body of the printer. A bearing 258 is provided in a carriage (not shown) that moves along the guide shaft 200. While a bearing of the carriage is normally formed of a hole of circular cross section, the bearing 258 is formed of a hole of pear-shaped cross section. A pair of inclined faces 258a and 258b are provided on an inner side of the bearing 258 so as to be in contact with a peripheral surface of the guide shaft 200.

When the carriage yaws, the normal bearing of circular cross section easily vibrates relative to the guide shaft in the yawing direction shown by arrow Y in FIG. 6. In contrast, in the structure shown in FIG. 6, drags from the guide shaft 200 act on the bearing 258 of the carriage in two directions of arrow A. That is, the carriage receives horizontal drag shown by arrow A via the shaft 258, in addition to a vertical drag against the gravity. For this reason, even when a horizontal external force that causes yawing is applied, the carriage is prevented to a certain limit from yawing in the Y-direction.

Japanese Patent Laid-Open No. 2003-285495 discloses that a guide member for guiding the movement of a carriage is formed of a sheet metal.

In recent years, particularly, there is a demand to decrease the height of a recording apparatus, such as a printer, or an image reading apparatus, such as a scanner, with the decrease in size. One conceivable method of decreasing the heights of the surroundings of the carriage is to remove a bottom face 258c from the bearing 258 disclosed in U.S. Pat. No. 5,366,305. However, when the bottom face 258 is removed, only the pair of inclined faces 258a and 258b support the weight of the carriage, and there is a need to increase the rigidity between the inclined faces 258a and 258b. Therefore, the size of the entire carriage including the bearing 258 is increased to reinforce the bearing 258, and it is difficult to reduce the total height of the carriage and its surroundings.

In the structure disclosed in Japanese Patent Laid-Open No. 2003-285495, the carriage needs to be pressed against a sheet metal rail via an elastic rubber member in order to prevent yawing. This lowers the positioning accuracy of the carriage and complicates the structure. For this reason, it is difficult to sufficiently prevent yawing vibration, and to respond to the increase in image definition.

### SUMMARY OF THE INVENTION

The present invention provides a carriage moving device that can precisely move a carriage while effectively suppressing yawing of the carriage.

A carriage moving device according to an aspect of the present invention includes a main guide member configured to guide movement of a carriage; a sub-guide member configured to guide the movement of the carriage and to regulate rotation of the carriage; and an engaging portion provided in the carriage and configured to slide relative to the main guide member. The main guide member includes a first flat face in contact with the engaging portion in a plane perpendicular to a moving direction of the carriage, and a second flat face in contact with the engaging portion, the second flat face extending in a direction such that a vertically upper portion is disposed farther from the first flat face than a vertically lower portion.

Further features of the present invention will become apparent from the following description of exemplary embodiments with reference to the attached drawings.

### BRIEF DESCRIPTION OF THE DRAWINGS

FIG. 1 is a perspective view of a recording apparatus to which a carriage moving device according to a first exemplary embodiment of the present invention is suitably applied.

FIG. 2 is a perspective view of the carriage moving device.

FIG. 3 is a cross-sectional view of the carriage moving device shown in FIG. 2, taken along a plane perpendicular to the carriage moving direction.

FIG. 4 is a cross-sectional view of a main guide member and an engaging portion in the carriage moving device, taken along a plane perpendicular to the carriage moving direction.

FIG. 5 is a cross-sectional view of a main guide member and an engaging portion in a carriage moving device according to a second exemplary embodiment of the present invention, taken along a plane perpendicular to the carriage moving direction.

FIG. 6 is a cross-sectional view showing a structure of a bearing in a carriage in the related art.

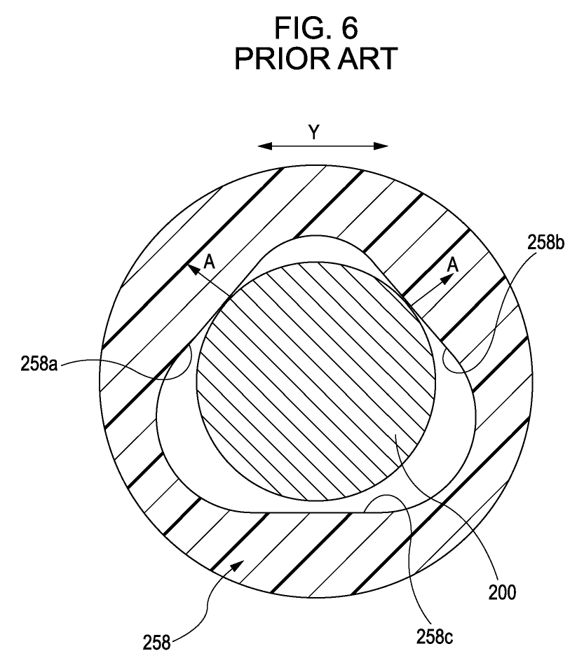

### DESCRIPTION OF THE EMBODIMENTS

Exemplary embodiments of the present invention will be specifically described below. The same reference numerals denote the same or corresponding components through the drawings.

### First Exemplary Embodiment

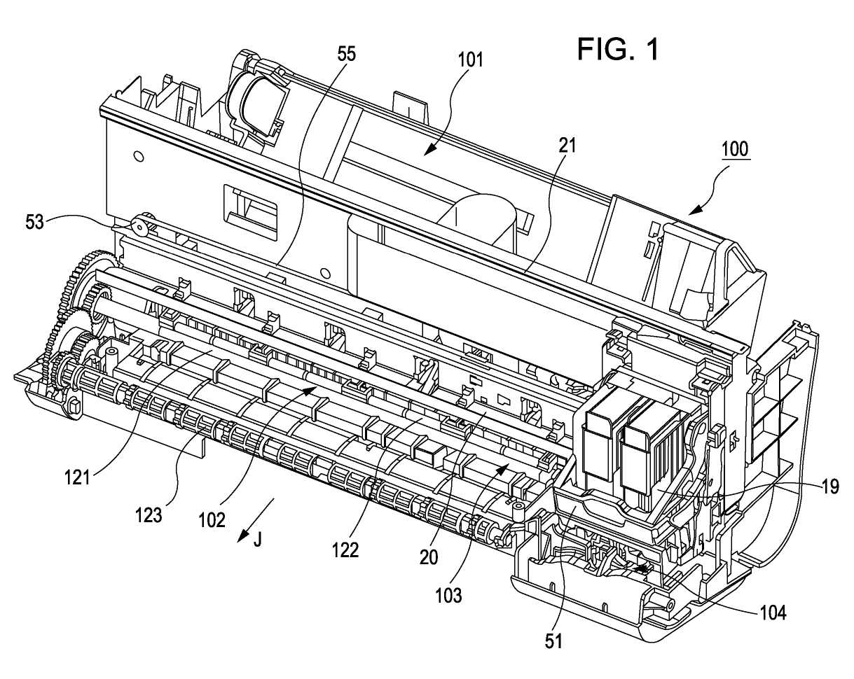

FIG. 1 is a perspective view of an inkjet recording apparatus to which a carriage moving device according to a first exemplary embodiment is suitably applied. Referring to FIG. 1, a recording apparatus 100 includes a sheet feeding unit 101 that feeds recording sheets serving as recording media into an apparatus main body, and a sheet conveying unit 102 that conveys the recording sheets through a recording region in the apparatus main body. The recording apparatus 100 also includes a recording unit 103 that records images on the recording sheets according to image information, and a recovery unit 104 that maintains and recovers the recording performance of a recording head.

Recording sheets stacked in the sheet feeding unit 101 are separated one by one by a sheet feeding roller, and are supplied to the sheet conveying unit 102. A separated recording sheet supplied to the sheet conveying unit 102 is conveyed through the recording unit 103 by a frictional force between a conveying roller 121 and a pinch roller 122. In the recording unit 103, an image is recorded on the recording sheet by a recording head 19 mounted on a carriage 51 that moves in the width direction of the recording sheet. The recorded recording sheet is ejected out of the apparatus main body (in the direction of arrow J) by an ejecting roller 123, which is driven in cooperation with the conveying roller 121, and a driven roller (e.g., a spur roller). In the inkjet recording apparatus, an image is recorded on a recording sheet by selectively discharging ink from a plurality of discharge ports provided in the recording head according to image information. The recovery unit 104 is disposed at a predetermined position within a moving range of the carriage 51 and outside a recording region. For example, the recovery unit 104 includes a cap that covers a discharging surface of the recording head 19, a negative-pressure producing source connected to the cap for suction recovery, and a wiper that wipes the discharging surface.

The recording unit 103 includes the carriage 51 that moves with the recording head 19 mounted thereon. The carriage 51 is supported so as to reciprocate along two guide rails 20 and 21 extending parallel to each other in the right-left direction in the apparatus main body. The guide rail 20 guides the movement of the carriage 51, and serves as a main guide member that supports the mass of the carriage 51. The other guide rail 21 regulates the rotation of the carriage 51 about the main guide member 20, and serves as a sub-guide member that auxiliary guides the movement of the carriage 51. A part of the carriage 51 is engaged with the main guide member 20 and the sub-guide member 21, thus constituting the carriage moving device. The recording head 19 is, for example, a thermal inkjet recording head. In this recording head, film boiling is caused in the ink by thermal energy applied from an electrothermal transducer provided in each discharge port, and the ink is discharged from the discharge port by utilizing the pressure change caused by growth and contraction of bubbles during film boiling.

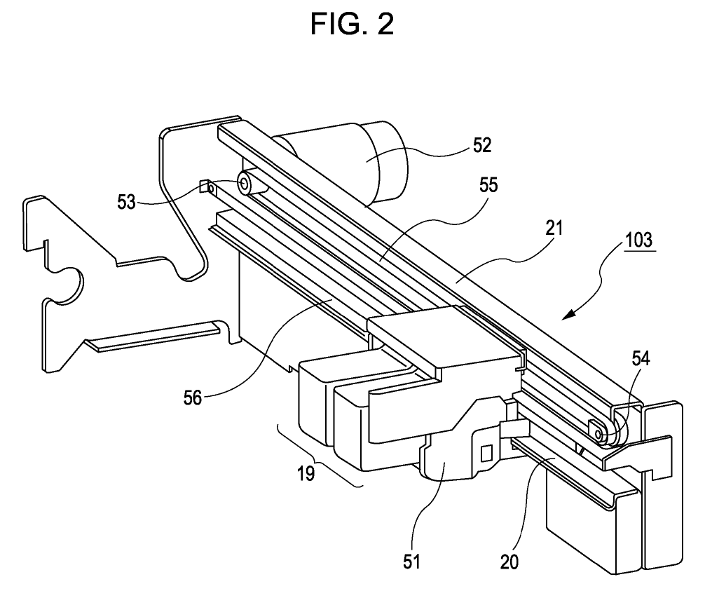

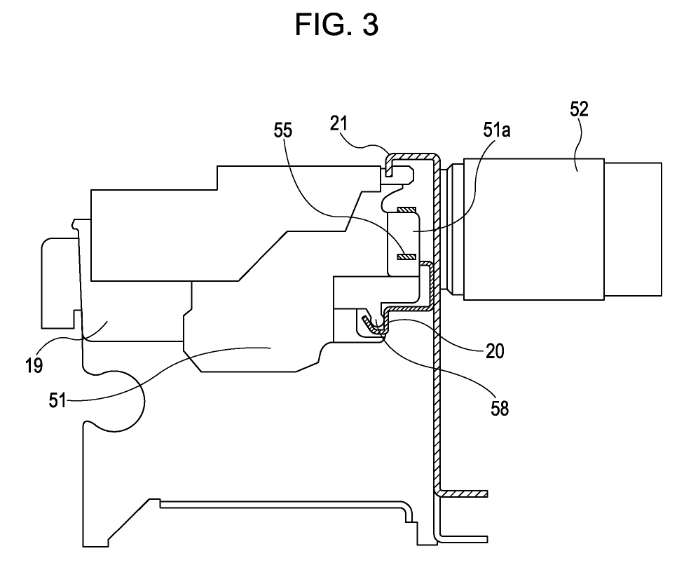

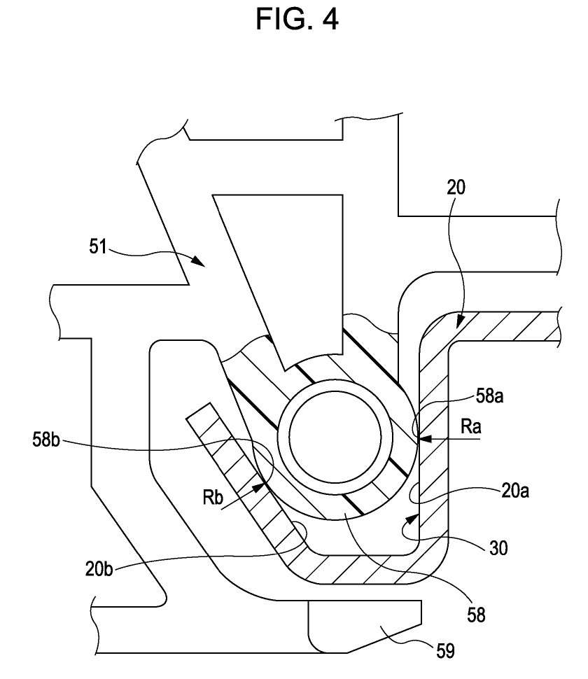

FIG. 2 is a perspective view of the carriage moving device according to the first exemplary embodiment. FIG. 3 is a cross-sectional view of the carriage moving device shown in FIG. 2, taken along a plane perpendicular to the carriage moving direction. FIG. 4 is a cross-sectional view of the main guide member (main guide rail) 20 and the sub-guide member (sub-guide rail) 21 in the carriage moving device, taken along a plane perpendicular to the carriage moving direction. In the carriage moving device shown in FIG. 2, the carriage 51 moves along the main guide member 20 and the sub-guide member 21. The carriage moving device also includes a carriage belt 55 connected to the carriage 51, a driving pulley 53 for driving the carriage belt 55, and a carriage motor 52, such as a DC motor, directly coupled to the driving pulley 53.

The driving pulley 53 is provided near one end (left end in FIG. 2) of the main guide member 20 and the sub-guide member 21, and an idler pulley 54 is provided near the other end (right end in FIG. 2). The carriage belt 55 is laid around the driving pulley 53 and the idler pulley 54 so as to extend parallel to the main guide member 20 and the sub-guide member 21 in a tensioned manner. A part of the carriage belt 55 is connected to the carriage 51. A linear encoder scale 56 also extends parallel to the main guide member 20 and the sub-guide member 21. A linear encoder sensor (not shown) that reads marks provided on the linear encoder scale 56 is mounted on the carriage 51. By reading the marks on the linear encoder scale 56 with the encoder sensor, information about the position of the carriage 51 can be obtained.

On the linear encoder scale 56, for example, marks are printed at a regular interval of 150 lpi (line per inch). This interval of 150 lpi corresponds to 25.4 mm/150≈169.3 μm. The position of the carriage 51 can be precisely detected by detecting the marks with the linear encoder sensor provided on the carriage 51. While the carriage 51 is moving, the moving speed of the carriage 51 can be calculated from the time interval between encoder signals from the linear encoder sensor.

As shown in FIG. 4, the carriage 51 has an engaging portion 58 that slides relative to the main guide member 20. A guide support surface 30 of the main guide member 20 that slides relative to the engaging portion 58 includes a first flat face 20a extending vertically, and a second flat face 20b extending in a direction such that a vertically upper portion is disposed farther from the first flat face 20a than a vertically lower portion. The engaging portion 58 can be formed of resin, and is in point contact with the first flat face 20a at a contact portion 58a and with the second flat face 20b at a contact portion 58b in a cross section perpendicular to the carriage moving direction. This structure allows drags Ra and Rb acting on the contact portions 58a and 58b with the first and second flat faces 20a and 20b to travel toward almost the center of the engaging portion 58.

This structure can prevent bending of the engaging portion 58 during movement of the carriage 51, and also can avoid vibration due to bending. Further, since the main guide member 20 does not need to be surrounded by the engaging portion 58, the height of the apparatus main body can be reduced. In the first exemplary embodiment, the main guide member 20 is formed by bending a stainless steel or a steel plate so as to be V-shaped in cross section. The engaging portion 58 can be provided at one position or a plurality positions in the carriage moving direction.

As shown in FIG. 3, the guide support surface 30 of the main guide member 20 that slides relative to the engaging portion 58 of the carriage 51 is V-shaped. For this reason, in order to enhance slidability between the main guide member 20 and the carriage 51, it is only necessary to apply lubricant oil on the first and second flat faces 20a and 20b. This can enhance ease of maintenance. Since the guide support surface 30 of the main guide member 20 is V-shaped, the applied lubricant oil will not drop off, and a low-viscosity lubricant oil can be applied. Further, the main guide member 20 is formed by bending a stainless steel plate or a steel plate in an L-shape, and is subjected to surface treatment as necessary. Both ends of the main guide member 20 are shaped so as to be fixedly fitted in or screwed to the chassis.

According to the above-described first exemplary embodiment, since the main guide member 20 can be made by sheet metal processing, the parts cost can be made lower than in the related art in which a solid round bar is processed. That is, the carriage moving device can perform high-quality recording or high-accuracy document reading with a simple and low-cost structure, and can also achieve high durability.

As shown in FIG. 4, the carriage 51 is provided with a fall-off preventing rib 59 protruding below the main guide member 20. The fall-off preventing rib 59 reliably prevents the carriage 51 from separating from the main guide member 20. A gap between the fall-off preventing rib 59 and the main guide member 20 can be set at approximately 0.5 mm. Even when the cap is press-fitted on the bottom discharging surface of the recording head 19 (FIG. 2) mounted on the carriage 51 in the inkjet recording apparatus, the fall-off preventing rib 59 prevents the carriage 51 from being lifted.

### Second Exemplary Embodiment

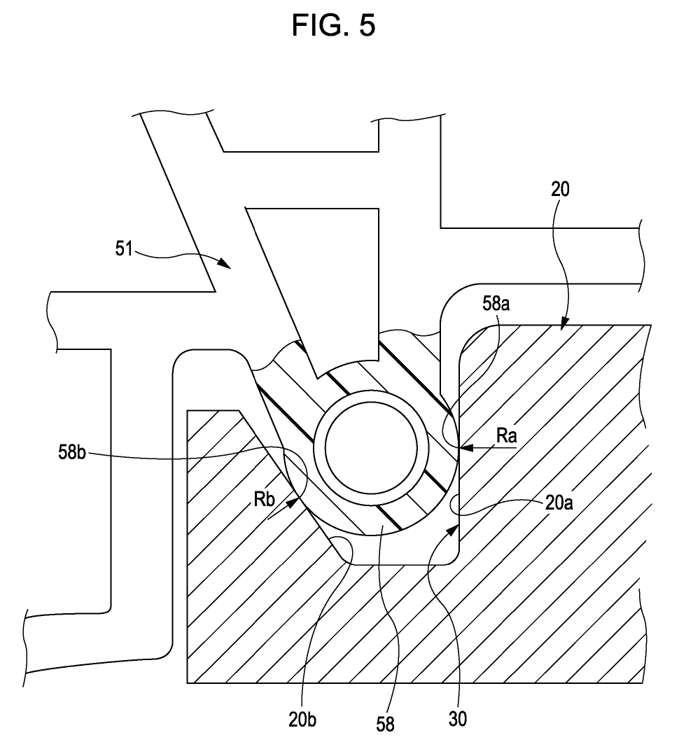

FIG. 5 is a cross-sectional view of a main guide member and an engaging portion of a carriage moving device according to a second exemplary embodiment of the present invention, taken along a plane perpendicular to the carriage moving direction. While the main guide member 20 is V-shaped in cross section by bending a metal sheet in the first exemplary embodiment, it is formed of a solid block extending in the right-left direction of the apparatus main body in the second exemplary embodiment. That is, a groove of valley-shaped cross section is formed in the solid block by, for example, machining. The groove extends in the right-left direction, and serves as a guide support portion 30. The valley of the main guide member 20 includes a first flat face 20a extending vertically, and a second flat face 20b extending in a direction such that a vertically upper portion is disposed farther from the first flat face 20a than a vertically lower portion. The first and second flat faces 20a and 20b define the V-shaped guide support portion 30 similar to that adopted in the first exemplary embodiment.

The second exemplary embodiment can also prevent an engaging portion 58 from bending during movement of the carriage 51, and can avoid vibration due to bending. Further, since the main guide member 20 does not need to be surrounded by the engaging portion 58, the height of the apparatus main body can be reduced.

In the above-described exemplary embodiments, the carriage moving device is applied to the recording apparatus that records an image with the recording head mounted on the carriage. The carriage moving devices according to the exemplary embodiments of the present invention can also be used in an image reading apparatus that reads a document with a reading sensor mounted on a carriage. In the image reading apparatus, image information about a document conveyed through a region corresponding to the above-described recording unit 103 is read with a moving reading sensor mounted on the carriage. The carriage moving device can also be used in an image reading and recording apparatus including a recording head and a reading sensor, in a manner similar to the above.

The recording apparatus to which the present invention is applied is not limited to a discrete recording apparatus such as a printer, a copying machine, a facsimile apparatus, or an image forming apparatus. The present invention is widely applicable to a multifunction system including some of these apparatuses, or a recording apparatus provided in a multifunction system such as a computer system. This also applies to an image reading apparatus and an image reading and recording apparatus. In this application, the image covers all outputtable images including characters and signs. Further, the materials and shapes of the recording sheet and the document are not particularly limited as long as image recording is possible or they can have image information. For example, paper, a plastic sheet, photographic paper, cloth, and an OHP sheet can be used as the recording sheet and the document.

According to the exemplary embodiments of the present invention, the carriage moving device can precisely move the carriage with a simple structure while effectively reducing yawing of the carriage.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-323663 filed Nov. 30, 2006, which is hereby incorporated by reference herein in its entirety.

What is claimed is:

1. A carriage moving device comprising:
a main guide member configured to guide movement of a carriage;
a sub-guide member configured to guide the movement of the carriage and to regulate rotation of the carriage; and
an engaging portion provided in the carriage and configured to slide relative to the main guide member,
wherein the main guide member includes a first flat face in contact with the engaging portion in a plane perpendicular to a moving direction of the carriage, and a second flat face in contact with the engaging portion, the second flat face extending in a direction such that a vertically upper portion is disposed farther from the first flat face than a vertically lower portion.

2. The carriage moving device according to claim 1, wherein the main guide member is formed of a plate material bent to have a V-shaped cross section.

3. The carriage moving device according to claim 1, wherein the main guide member has a groove.

4. The carriage moving device according to claim 1, wherein the engaging portion is formed of a continuous face extending in the moving direction of the carriage.

5. A recording apparatus comprising:
a carriage mounting a recording head configured to record an image on a recording sheet;
a main guide member configured to guide movement of the carriage;
a sub-guide member configured to guide the movement of the carriage and to regulate rotation of the carriage; and
an engaging portion provided in the carriage and configured to slide relative to the main guide member,
wherein the main guide member includes a first flat face in contact with the engaging portion in a plane perpendicular to a moving direction of the carriage, and a second flat face in contact with the engaging portion, the second flat face extending in a direction such that a vertically upper portion is disposed farther from the first flat face than a vertically lower portion.

6. An image reading apparatus comprising:
a carriage mounting a reading sensor configured to read a document;
a main guide member configured to guide movement of the carriage;
a sub-guide member configured to guide the movement of the carriage and to regulate rotation of the carriage; and
an engaging portion provided in the carriage and configured to slide relative to the main guide member,
wherein the main guide member includes a first flat face in contact with the engaging portion in a plane perpendicular to a moving direction of the carriage, and a second flat face in contact with the engaging portion, the second flat face extending in a direction such that a vertically upper portion is disposed farther from the first flat face than a vertically lower portion.
